(19) United States
(12) Patent Application Publication
(10) Pub. No.: US 2025/0121613 A1
(43) Pub. Date: Apr. 17, 2025

(54) INK JET RECORDING DEVICE AND METHOD OF MANUFACTURING DRYING CYLINDER

(71) Applicant: FUJIFILM Corporation, Tokyo (JP)

(72) Inventor: Hayate NAKAMURA, Kanagawa (JP)

(73) Assignee: FUJIFILM Corporation, Tokyo (JP)

(21) Appl. No.: 19/002,572

(22) Filed: Dec. 26, 2024

Related U.S. Application Data
(63) Continuation of application No. PCT/JP2023/019634, filed on May 26, 2023.

(30) Foreign Application Priority Data
Jul. 26, 2022 (JP) 2022-118859

(51) Int. Cl. B41J 11/00; B24B 29/04; B41J 15/16; B41J 29/377

(52) U.S. Cl. CPC B41J 11/00242; B24B 29/04; B41J 11/00216; B41J 15/16; B41J 29/377

(57) ABSTRACT

Provided are an ink jet recording device and a method of manufacturing a drying cylinder, which suppress drying unevenness while suppressing slippage of a recording medium. The ink jet recording device includes: an ink jet head that applies an ink to a recording surface of a recording medium to form an image; and a drying cylinder that heats the recording medium by bringing the recording surface of the recording medium to which the ink is applied into contact with an outer peripheral surface of the drying cylinder, in which the outer peripheral surface of the drying cylinder has a maximum static friction coefficient of 0.54 or less and an arithmetic average roughness of 1.6 μm or more, and a solvent amount of the ink on the recording surface that comes into contact with the outer peripheral surface of the drying cylinder is 200 μg/cm² or less.

### CROSS-REFERENCE TO RELATED APPLICATIONS

The present application is a Continuation of PCT International Application No. PCT/JP2023/019634 filed on May 26, 2023 claiming priority under 35 U.S.C § 119(a) to Japanese Patent Application No. 2022-118859 filed on Jul. 26, 2022. Each of the above applications is hereby expressly incorporated by reference, in its entirety, into the present application.

### BACKGROUND OF THE INVENTION

### 1. Field of the Invention

The present invention relates to an ink jet recording device and a method of manufacturing a drying cylinder, and particularly relates to a technique of drying a recording medium on which an image is formed.

### 2. Description of the Related Art

It is known that a rub resistance and blocking can be suppressed by drying a recording medium on which ink is applied to form an image, such that an amount of a residual solvent is a certain amount or less. However, in a double-sided roll printer that forms images on both surfaces of a roll substrate, only by a certain amount or more of drying, it is difficult to prevent damage to the image on an uneven surface required to suppress slippage of the recording medium during transportation.

In the first place, some ink jet printing devices have a drying cylinder that dries an image by heat transfer after the image is formed on a recording medium. For example, JP2020-082650A discloses a medium drying device comprising a heating unit that heats a peripheral surface of a rotating cylindrical drum, and a drying unit that brings the circumferential surface into contact with a front surface side of a long continuous printed medium to which a liquid containing a resin is adhered, and dries the liquid adhered to a back surface side.

### SUMMARY OF THE INVENTION

In order to efficiently dry a recording medium on a drying cylinder, it is preferable that a contact area between the drying cylinder and the recording medium is as large as possible. However, in a case where the drying cylinder has a flat structure, slippage may occur due to air (entrained air) generated between the drying cylinder and the recording medium, and transport performance may deteriorate. As a solution, a surface of the drying cylinder is often processed to have an uneven shape such as a suction or grooved roll for allowing the entrained air to escape. On the other hand, in a double-sided printer or the like, in drying after image formation on a back surface, an image formation region on a front surface where the image is previously formed comes into contact with a protruding portion on the surface of the drying cylinder, and thus an ink film is peeled off at a contact portion, and image defects such as white spots may occur.

The present invention has been made in view of such circumstances, and an object of the present invention is to provide an ink jet recording device and a method of manufacturing a drying cylinder, which suppress drying unevenness while suppressing slippage of a recording medium.

In order to achieve the above object, according to a first aspect of the present disclosure, there is provided an ink jet recording device comprising: an ink jet head that applies an ink to a recording surface of a recording medium to form an image; and a drying cylinder that heats the recording medium by bringing the recording surface of the recording medium to which the ink is applied into contact with an outer peripheral surface of the drying cylinder, in which the outer peripheral surface of the drying cylinder has a maximum static friction coefficient of 0.54 or less and an arithmetic average roughness of 1.6 μm or more, and a solvent amount of the ink on the recording surface that comes into contact with the outer peripheral surface of the drying cylinder is 200 μg/cm² or less. According to this aspect, it is possible to suppress the drying unevenness while suppressing the slippage of the recording medium.

An ink jet recording device according to a second aspect of the present disclosure is the ink jet recording device according to the first aspect, further comprising a transport device that transports the recording medium, in which the transport device applies a tension of 50 N/m or more and 800 N/m or less to the recording medium.

An ink jet recording device according to a third aspect of the present disclosure is the ink jet recording device according to the first or second aspect, in which the drying cylinder includes a heater, and the heater sets a temperature of the outer peripheral surface of the drying cylinder to 30° C. or higher and 300° C. or lower.

An ink jet recording device according to a fourth aspect of the present disclosure is the ink jet recording device according to any one of the first to third aspects, in which the drying cylinder includes a motor that rotates the drying cylinder about a shaft of the drying cylinder, and the drying cylinder transports the recording medium while holding the recording medium on the outer peripheral surface.

An ink jet recording device according to a fifth aspect of the present disclosure is the ink jet recording device according to any one of the first to fourth aspects, in which a moisture content of the recording medium before the ink is applied to the recording surface is 1.2% or more and 14.3% or less.

An ink jet recording device according to a sixth aspect of the present disclosure is the ink jet recording device according to any one of the first to fifth aspects, in which the drying cylinder sets a temperature of the recording medium to 90° C. or higher and 180° C. or lower.

An ink jet recording device according to a seventh aspect of the present disclosure is the ink jet recording device according to any one of the first to sixth aspects, in which the ink contains a wax, and a melting point of the wax is 90° C. or lower. Furthermore, the melting point of the wax is preferably 47° C. or higher.

An ink jet recording device according to an eighth aspect of the present disclosure is the ink jet recording device according to any one of the first to seventh aspects, in which the outer peripheral surface of the drying cylinder has the maximum static friction coefficient of 0.1 or more and the arithmetic average roughness of 10.4 μm or less, and the solvent amount of the ink on the recording surface that comes into contact with the outer peripheral surface of the drying cylinder is 100 μg/cm² or more. The solvent amount of the ink on the recording surface that comes into contact with the outer peripheral surface of the drying cylinder is more preferably 148 μg/cm² or less.

In order to achieve the above object, according to a ninth aspect of the present disclosure, there is provided an ink jet recording device comprising: a first ink jet head that applies an ink to a first recording surface of a recording medium to form an image; a first drying cylinder that heats the recording medium by bringing a second recording surface, which is an opposite surface of the first recording surface of the recording medium to which the ink is applied, into contact with a first outer peripheral surface; a reversing mechanism that reverses front and back sides of the recording medium; a second ink jet head that applies the ink to the second recording surface of the recording medium to form an image; a second drying cylinder that heats the recording medium by bringing the first recording surface of the recording medium into contact with a second outer peripheral surface, in which a solvent amount of the ink on the first recording surface in the first drying cylinder is 200 μg/cm² or less, and the second outer peripheral surface of the second drying cylinder has a maximum static friction coefficient of 0.54 or less and an arithmetic average roughness of 1.6 μm or more. According to this aspect, it is possible to suppress the drying unevenness while suppressing the slippage of the recording medium.

In order to achieve the above object, according to a tenth aspect of the present disclosure, there is provided a method of manufacturing a drying cylinder, comprising: performing a roughening treatment on an outer peripheral surface of a cylinder having a cylindrical shape; and performing a smoothing treatment on the outer peripheral surface on which the roughening treatment is performed, to make the outer peripheral surface have a maximum static friction coefficient of 0.54 or less and an arithmetic average roughness of 1.6 μm or more. According to this aspect, it is possible to manufacture a drying cylinder that suppresses the drying unevenness while suppressing the slippage of the recording medium.

A method of manufacturing a drying cylinder according to an eleventh aspect is the method of manufacturing a drying cylinder according to the tenth aspect, in which, in the smoothing treatment, a maximum height roughness of the outer peripheral surface of the cylinder is reduced by 0.35 μm or more.

A method of manufacturing a drying cylinder according to a twelfth aspect is the method of manufacturing a drying cylinder according to the tenth or eleventh aspect, in which the smoothing treatment is performed by buff polishing.

According to the present invention, it is possible to suppress the drying unevenness while suppressing the slippage of the recording medium.

### BRIEF DESCRIPTION OF THE DRAWINGS

FIG. 1 is an overall configuration diagram of an ink jet recording device.

FIG. 2 is a configuration diagram showing an outline of a printing and main drying unit.

FIG. 3 is a perspective view of a drying cylinder.

FIG. 4 is a block diagram showing an electric configuration of the ink jet recording device.

FIG. 5 is a graph showing a result of evaluation of a degree of an image defect.

FIGS. 6A to 6D is an enlarged image of an outer peripheral surface of the drying cylinder.

FIG. 7 is a graph showing a relationship between an arithmetic average roughness and a maximum static friction coefficient of the outer peripheral surface of the drying cylinder.

FIG. 8 is a table showing an arithmetic average roughness of the outer peripheral surface of the drying cylinder before and after smoothing processing.

FIG. 9 is a table showing evaluation results of white spots and blisters.

FIG. 10 is a configuration diagram showing an outline of a printing and main drying unit according to a first modification example.

FIG. 11 is a configuration diagram showing an outline of a printing and main drying unit according to a second modification example.

### DESCRIPTION OF THE PREFERRED EMBODIMENTS

Hereinafter, a preferred embodiment of the present invention will be described with reference to the accompanying drawings. In the following, a traveling direction of a substrate S is referred to as a transport direction, and a direction perpendicular to the transport direction and parallel to a recording surface of the substrate S is referred to as a width direction.

### <Ink Jet Recording Device>

### [Overall Configuration]

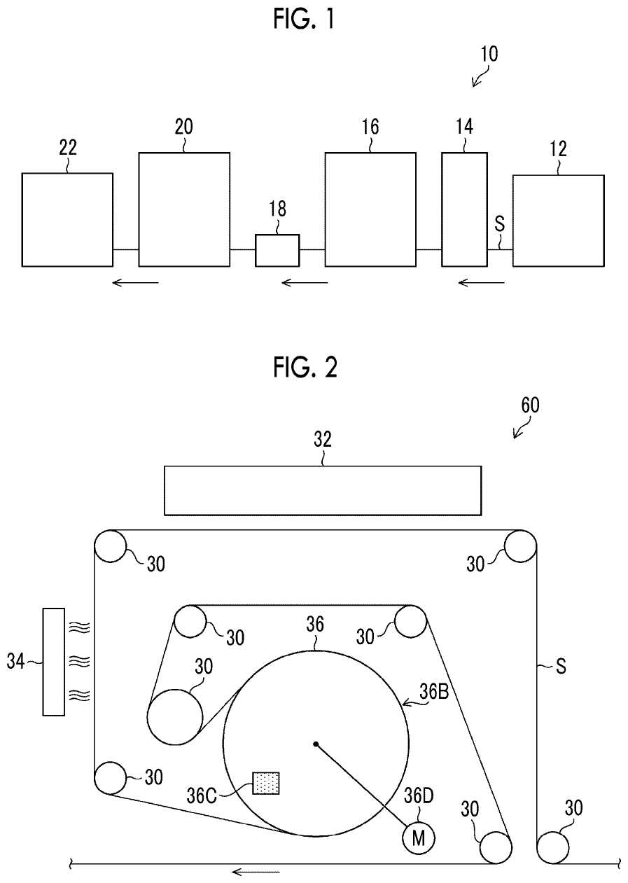

FIG. 1 is an overall configuration diagram of an ink jet recording device 10. The ink jet recording device 10 is a printing system that transports a substrate S, which is a long roll-shaped recording medium, in a so-called roll-to-roll method and forms an image by aqueous ink jet printing of a single-pass method without applying a pretreatment liquid. As shown in FIG. 1, the ink jet recording device 10 comprises a paper feed unit 12, a pre-drying unit 14, a front surface printing and main drying unit 16, a reversing unit 18, a back surface printing and main drying unit 20, and a paper discharge unit 22.

The paper feed unit 12 comprises a delivery roller (not shown) around which the substrate S on which the image is not yet formed is wound in a roll shape. The paper feed unit 12 supplies the substrate S on which the image is not yet formed by rotationally driving the delivery roller by a motor (not shown). The substrate S supplied from the delivery roller is transported to the pre-drying unit 14.

The pre-drying unit 14 heats and preliminarily dries the substrate S while transporting the substrate S, by a heating device (not shown). The substrate S discharged from the pre-drying unit 14 is transported to the front surface printing and main drying unit 16.

The front surface printing and main drying unit 16 applies aqueous ink to a front surface of the substrate S (an example of a “recording surface” and an example of a “first recording surface”) using an ink jet head 32 (see FIG. 2, an example of a “first ink jet head”) while transporting the substrate S, and forms an image. In addition, the front surface printing and main drying unit 16 dries the aqueous ink applied to the substrate S by a radiation heating unit 34 (see FIG. 2) and a drying cylinder 36 (see FIG. 2) while transporting the substrate S. The substrate S discharged from the front surface printing and main drying unit 16 is transported to the reversing unit 18.

The reversing unit 18 includes a turn bar (not shown). The turn bar (an example of a “reversing mechanism”) reverses front and back sides of the substrate S. The substrate S of which the front and back sides are reversed is transported to the back surface printing and main drying unit 20.

The back surface printing and main drying unit 20 is configured similarly to the front surface printing and main drying unit 16. The back surface printing and main drying unit 20 applies aqueous ink to a back surface of the substrate S (an example of a “recording surface” and an example of a “second recording surface”) using the ink jet head 32 (an example of a “second ink jet head”) while transporting the substrate S, and forms an image. In addition, the back surface printing and main drying unit 20 dries the aqueous ink applied to the substrate S by the radiation heating unit 34 and the drying cylinder 36 while transporting the substrate S. The substrate S discharged from the back surface printing and main drying unit 20 is transported to the paper discharge unit 22.

The paper discharge unit 22 comprises a winding roll (not shown) connected to a motor (not shown). The winding roll is rotationally driven by the motor so that the paper discharge unit 22 winds the substrate S on which the image is formed around the winding roll.

### [Printing and Main Drying Unit]

The front surface printing and main drying unit 16 and the back surface printing and main drying unit 20 have the same configuration. Here, a printing and main drying unit 60 will be described.

FIG. 2 is a configuration diagram showing an outline of the printing and main drying unit 60. The printing and main drying unit 60 comprises a plurality of pass rollers 30, the ink jet head 32, the radiation heating unit 34, and the drying cylinder 36.

The plurality of pass rollers 30 are disposed on a transport path of the substrate S in the printing and main drying unit 60. The substrate S carried into the printing and main drying unit 60 is transported inside the printing and main drying unit 60 by the pass rollers 30 and is discharged to the outside of the printing and main drying unit 60.

The ink jet head 32 is disposed at a position facing the recording surface of the substrate S to be transported. The recording surface of the substrate S is the front surface of the substrate S in a case of the front surface printing and main drying unit 16, and is the back surface of the substrate S in a case of the back surface printing and main drying unit 20. The ink jet head 32 is a liquid jetting head that forms an image by applying the aqueous ink to the recording surface of the substrate S by an ink jet method. The ink jet head 32 is configured as a line type recording head that can form an image on the transported substrate S by one-time scanning. The ink jet head 32 comprises a nozzle surface (not shown) on which a plurality of nozzles, which are jetting ports of the aqueous ink, are two-dimensionally arranged, and the nozzle surface is disposed to face the recording surface of the substrate S.

The ink jet head 32 can be configured by connecting a plurality of head modules in the width direction of the substrate S. The aqueous ink is supplied to the ink jet head 32 from an ink tank (not shown) via a pipe path (not shown).

The aqueous ink refers to an ink obtained by dissolving or dispersing a coloring material such as a dye or a pigment in water and a water-soluble solvent. Here, an aqueous pigment ink is used as the aqueous ink. In addition, the aqueous ink contains a wax.

The substrate S is guided by the pass rollers 30 and transported from a position facing the ink jet head 32 to a position facing the radiation heating unit 34.

The radiation heating unit 34 includes an infrared heater (not shown). The infrared heater heats the substrate S by radiating infrared rays toward the surface of the substrate S. The radiation heating unit 34 may comprise a hot air fan that supplies hot air to the surface of the substrate S.

The substrate S is guided by the pass rollers 30 and transported to the drying cylinder 36 from a position facing the radiation heating unit 34.

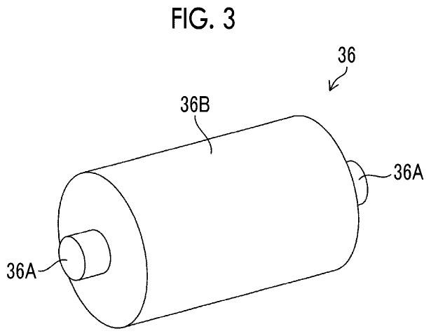

FIG. 3 is a perspective view of the drying cylinder 36. As shown in FIG. 3, the drying cylinder 36 is formed of a cylindrical steel use stainless (SUS), and comprises a rotation shaft 36A and an outer peripheral surface 36B.

Returning to the description of FIG. 2, the substrate S is wound around the outer peripheral surface 36B of the drying cylinder 36. The outer peripheral surface 36B of the drying cylinder 36 is heated by a heater 36C provided inside the drying cylinder 36. The drying cylinder 36 heats the substrate S by bringing the substrate S into contact with the outer peripheral surface 36B. In addition, the drying cylinder 36 is rotationally driven about the rotation shaft 36A by a motor 36D. The drying cylinder 36 rotates about the rotation shaft 36A while holding an opposite surface, which is a surface of the substrate S opposite to the recording surface, on the outer peripheral surface 36B, and thus the substrate S is transported while being heated from the opposite surface. The opposite surface of the substrate S is the back surface of the substrate S in a case of the front surface printing and main drying unit 16, and is the front surface of the substrate S in a case of the back surface printing and main drying unit 20.

The substrate S heated by the drying cylinder 36 is guided by the pass rollers 30 and discharged from the drying cylinder 36 to the outside of the printing and main drying unit 60.

### [Electric Configuration]

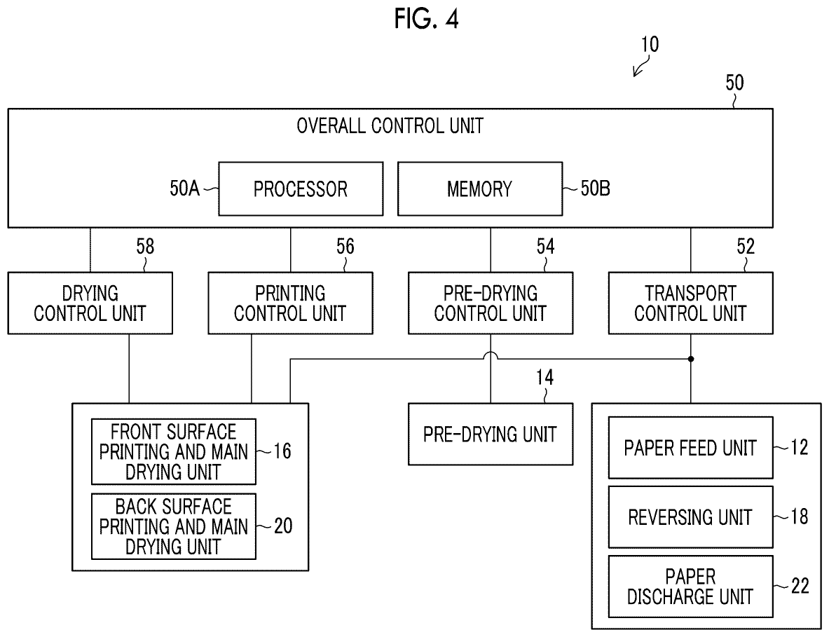

FIG. 4 is a block diagram showing an electric configuration of the ink jet recording device 10. The ink jet recording device 10 comprises an overall control unit 50, a transport control unit 52, a pre-drying control unit 54, a printing control unit 56, and a drying control unit 58.

The overall control unit 50 performs overall control of the ink jet recording device 10. The overall control unit 50 comprises a processor 50A and a memory 50B.

The processor 50A executes a command stored in the memory 50B. A hardware structure of the processor 50A is various processors as described below. The various processors include a central processing unit (CPU) that is a general-purpose processor acting as various functional units by executing software (program), a graphics processing unit (GPU) that is a processor specialized in image processing, a programmable logic device (PLD) such as a field programmable gate array (FPGA) that is a processor having a circuit configuration changeable after manufacture, a dedicated electric circuit such as an application specific integrated circuit (ASIC) that is a processor having a circuit configuration dedicatedly designed to execute specific processing, and the like.

One processing unit may be configured by using one of these various processors, or may be configured by using two or more processors of the same type or different types (for example, a plurality of FPGAs, or a combination of a CPU and an FPGA, or a combination of a CPU and a GPU). In addition, a plurality of functional units may be configured by one processor. As an example in which one processor constitutes the plurality of functional units, first, there is a form in which a combination of one or more CPUs and software constitutes one processor, as represented by a computer, such as a client and a server, and the processor acts as the plurality of functional units. Second, there is a form in which a processor that realizes functions of the entire system including the plurality of functional units with one integrated circuit (IC) chip is used, as represented by a system on chip (SoC) or the like. As described above, various functional units are configured by using one or more of the above-described various processors as hardware structures.

Furthermore, the hardware structure of the various processors is more specifically an electric circuit (circuitry) in which circuit elements such as semiconductor elements are combined.

The memory 50B stores a command to be executed by the processor 50A. The memory 50B includes a random access memory (RAM) and a read only memory (ROM). The processor 50A executes software using various programs and parameters stored in the ROM with the RAM as a work area and executes various types of processing for controlling the ink jet recording device 10 using the parameters stored in the ROM or the like.

The transport control unit 52 controls the motor of the paper feed unit 12, the turn bar of the reversing unit 18, and the motor (an example of a “transport device”) of the paper discharge unit 22 to apply a predetermined transport tension (an example of a “tension”) to the substrate S and transport the substrate S at a predetermined transport speed. In addition, the transport control unit 52 controls driving of the drying cylinders 36 of the front surface printing and main drying unit 16 and the back surface printing and main drying unit 20.

The pre-drying control unit 54 controls the heating device of the pre-drying unit 14 to preliminarily dry the substrate S.

The printing control unit 56 controls the ink jet heads 32 of the front surface printing and main drying unit 16 and the back surface printing and main drying unit 20 to form an image on the substrate S. In addition, the drying control unit 58 controls the radiation heating units 34 and the drying cylinders 36 of the front surface printing and main drying unit 16 and the back surface printing and main drying unit 20 to dry the ink applied to the substrate S.

### [Operation of Ink Jet Recording Device]

The substrate S supplied from the paper feed unit 12 is transported to the pre-drying unit 14 and is preliminarily dried. The preliminarily dried substrate S is transported to the front surface printing and main drying unit 16.

In the front surface printing and main drying unit 16, the substrate S is guided by the pass rollers 30 and transported to a position facing the ink jet head 32. The ink jet head 32 jets liquid droplets of the aqueous ink toward the front surface of the substrate S. The image is formed on the front surface of the substrate S by the liquid droplets adhering to the front surface of the substrate S.

Subsequently, the substrate S is transported to a position facing the radiation heating unit 34. The radiation heating unit 34 heats the substrate S with the infrared heater. In this manner, the drying of the aqueous ink applied to the front surface of the substrate S is promoted.

Further, the substrate S is guided by the pass rollers 30 and transported to the drying cylinder 36 from a position facing the radiation heating unit 34. The substrate Sis wound around the outer peripheral surface 36B of the drying cylinder 36. The drying cylinder 36 rotates while bringing the outer peripheral surface 36B into contact with the back surface of the substrate S, thereby transporting the substrate S while heating the substrate S from the back surface. In this manner, the drying of the aqueous ink applied to the front surface of the substrate S is promoted.

The substrate S on which the aqueous ink applied to the front surface is dried is discharged to the outside of the front surface printing and main drying unit 16.

The substrate S discharged from the front surface printing and main drying unit 16 is transported to the reversing unit 18, and the front and back sides thereof are reversed by the turn bar. The substrate S of which the front and back sides are reversed is transported to the back surface printing and main drying unit 20.

In the back surface printing and main drying unit 20, the substrate S is guided by the pass rollers 30 and transported to a position facing the ink jet head 32. The ink jet head 32 jets liquid droplets of the aqueous ink toward the back surface of the substrate S. The image is formed on the back surface of the substrate S by the liquid droplets adhering to the back surface of the substrate S.

Subsequently, the substrate S is transported to a position facing the radiation heating unit 34. The radiation heating unit 34 heats the substrate S with the infrared heater. In this manner, the drying of the aqueous ink applied to the back surface of the substrate S is promoted.

Further, the substrate S is guided by the pass rollers 30 and transported to the drying cylinder 36 from a position facing the radiation heating unit 34. The substrate Sis wound around the outer peripheral surface 36B of the drying cylinder 36. The drying cylinder 36 rotates while bringing the outer peripheral surface 36B into contact with the front surface of the substrate S, thereby transporting the substrate S while heating the substrate S from the front surface. In this manner, the drying of the aqueous ink applied to the back surface of the substrate S is promoted.

The substrate S on which the aqueous ink applied to the back surface is dried is discharged to the outside of the back surface printing and main drying unit 20. The substrate S discharged from the back surface printing and main drying unit 20 is transported to the paper discharge unit 22 and is wound around the winding roll.

As described above, the ink jet recording device 10 transports the substrate S in the order of the paper feed unit 12, the pre-drying unit 14, the front surface printing and main drying unit 16, the reversing unit 18, the back surface printing and main drying unit 20, and the paper discharge unit 22, and performs each treatment on the substrate S to manufacture a printed matter.

### <Details of Printing and Main Drying Unit>

### [Maximum Static Friction Coefficient of Drying Cylinder]

A relationship between the maximum static friction coefficient of the outer peripheral surface 36B of the drying cylinder 36 of the back surface printing and main drying unit 20 and an image defect on the front surface of the substrate S due to the contact with the outer peripheral surface 36B was investigated.

Here, a degree of an image defect generated in a case where the front surface of the substrate S on which a blue solid image was formed was rubbed with the outer peripheral surface 36B of the drying cylinder 36 at a surface pressure of 0.42 [kg/cm²] was evaluated. The degree of the image defect was rated as follows. The grade 3 or higher is pass.
5: very good
4: good
3: acceptable
2: poor
1: very poor

The maximum static friction coefficient was changed using two polishing methods of buff polishing and abrasive polishing. The maximum static friction coefficient was measured by a gradient method partially conforming to JIS P 8147:2010, using a drying cylinder sample with respect to the substrate.

As the substrate, OK Top Coat (manufactured by Oji Paper Co., Ltd., “Top Coat” is a registered trademark) having a basis weight of 127 [grams per square meter (gsm)] was used. The drying cylinder sample has a cylindrical shape with φ100 [mm] and a length of 1000 [mm].

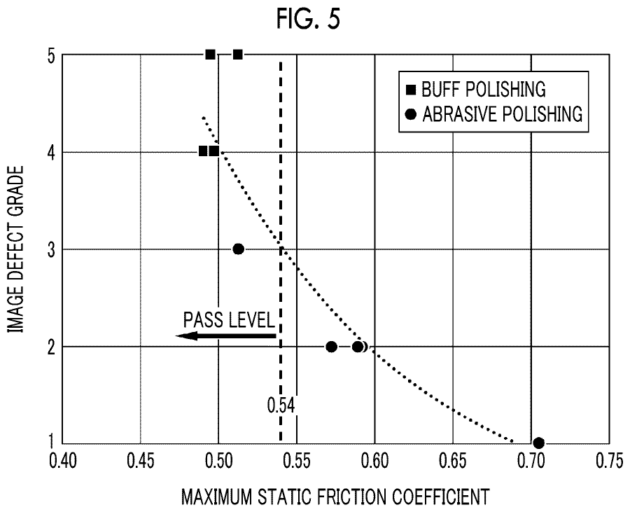

FIG. 5 is a graph showing a result of the evaluation of the degree of the image defect, in which the maximum static friction coefficient is plotted on a horizontal axis and an image defect grade is plotted on a vertical axis. In addition, a dotted line shown in FIG. 5 is an approximate curve for each plotted point. As shown in FIG. 5, it was found that the smaller the maximum static friction coefficient, the better the image defect grade, and the maximum static friction coefficient of 0.54 or less is a pass level.

The maximum static friction coefficient may be measured using a portable friction meter 3D MUSE TYPE37i (manufactured by Shinto Scientific Co., Ltd.). With this device, a drying cylinder sample is not required.

### [Surface Arithmetic Average Roughness of Drying Cylinder]

Next, the slippage of the substrate during the transport in the drying cylinder will be investigated. In general, in a case of roll transport, it is sufficient to reduce a floating amount of the substrate from the drying cylinder in order to suppress the slippage. Here, a floating amount h₀ [μm] of the substrate from the drying cylinder can be represented by the following Expression 1.

$${h}_{0} = 0.589 \times R \times {( 6 \times η \times ( Ur + Uw ) / ( T / w ) )}^{2 / 3} \qquad ( Expression 1 )$$

In Expression 1, R is a radius [m] of a drying cylinder, η is a gas viscosity [Pa×s], T is a tension [N] of a substrate, w is a width (length in a width direction) [m] of the substrate, Ur is a speed [m/min] of the drying cylinder, and Uw is a transport speed [m/min] of the substrate.

In general, the substrate does not reach full floating in a case where h₀<3σ is satisfied. σ is a composite surface roughness [μm] of the outer peripheral surface of the drying cylinder, and can be represented by the following Expression 2.

$$σ = {( {Rq}^{2} + {Rw}^{2} )}^{1 / 2} \qquad ( Expression 2 )$$

In Expression 2, Rq is a root mean square roughness [μm] of the outer peripheral surface of the drying cylinder represented by Rq=Ra×1.25 in a case where Ra is an arithmetic average roughness [μm] of the outer peripheral surface of the drying cylinder, and Rw is an arithmetic average roughness [μm] of the surface of the substrate.

From Expression 2, a key parameter of the floating amount is the arithmetic average roughness of the outer peripheral surface of the drying cylinder, and the larger the arithmetic average roughness, the better.

Here, in a case where R=0.35 [m], η=0.000018 [Pa×s], T=350 [N], w=0.52 [m], Ur=40 [m/min], Uw=40 [m/min], and Rw=1.5 [μm] are set as a configuration example of the ink jet recording device 10, the arithmetic average roughness Ra [μm] of the outer peripheral surface of the drying cylinder, which is required for a theoretical floating amount not to reach full floating, is 1.6 [μm] or more.

### [Method of Processing Drying Cylinder]

A method of processing a drying cylinder for changing a maximum static friction coefficient and an arithmetic average roughness of the outer peripheral surface (an example of a “method of manufacturing a drying cylinder”) includes first performing a roughening treatment (blasting treatment) on an outer peripheral surface of a cylinder having a cylindrical shape, next performing a plating treatment on the outer peripheral surface, and finally performing a smoothing treatment (polishing) on the outer peripheral surface.

Examples of the blasting treatment include sand blasting, shot blasting, grit blasting, and wet blasting.

Examples of a polishing method include abrasive polishing, buff polishing, barrel polishing, belt polishing, and lapping polishing.

For the abrasive polishing, alumina, silicon carbide, diamond, and cubic boron nitride (CBN) are used. For the buff polishing, linen, cotton, wool, and sponge are used.

The maximum static friction coefficient and the arithmetic average roughness of the outer peripheral surface of the drying cylinder can be changed by changing the blasting treatment and the polishing method. For example, as shown in FIG. 5, the maximum static friction coefficient tends to be smaller in the buff polishing than in the abrasive polishing.

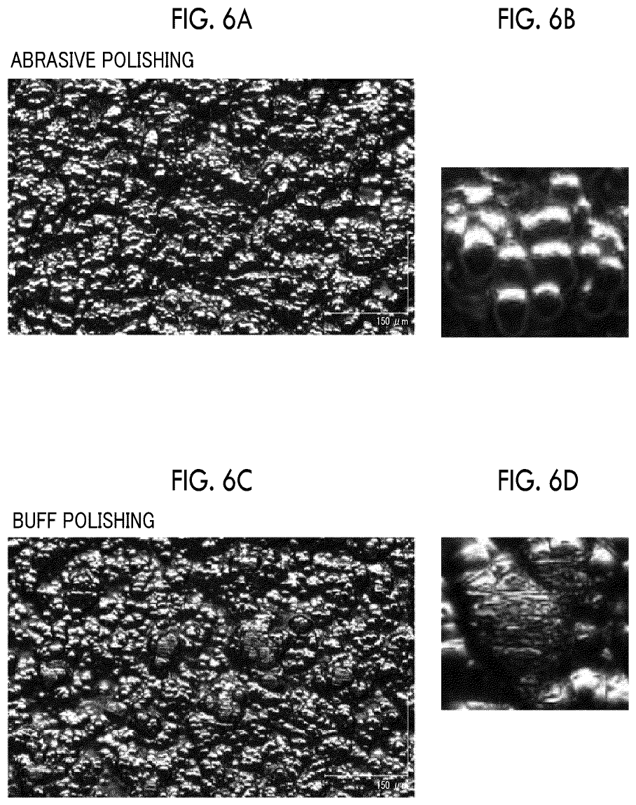

FIGS. 6A to 6D is an enlarged image of the outer peripheral surface of the drying cylinder. FIG. 6A is an enlarged image of the outer peripheral surface subjected to the abrasive polishing, and FIG. 6B is an image obtained by further enlarging FIG. 6A. In addition, FIG. 6C is an enlarged image of the outer peripheral surface subjected to the buff polishing, and FIG. 6D is an image obtained by further enlarging FIG. 6C. As shown in FIGS. 6A to 6D, the outer peripheral surface processed by the buff polishing is flatter than the outer peripheral surface processed by the abrasive polishing. Therefore, it is considered that the surface pressure and the maximum static friction coefficient are lower in the buff polishing than in the abrasive polishing. That is, as the method of processing the drying cylinder, it is preferable to perform a smoothing treatment by the buff polishing.

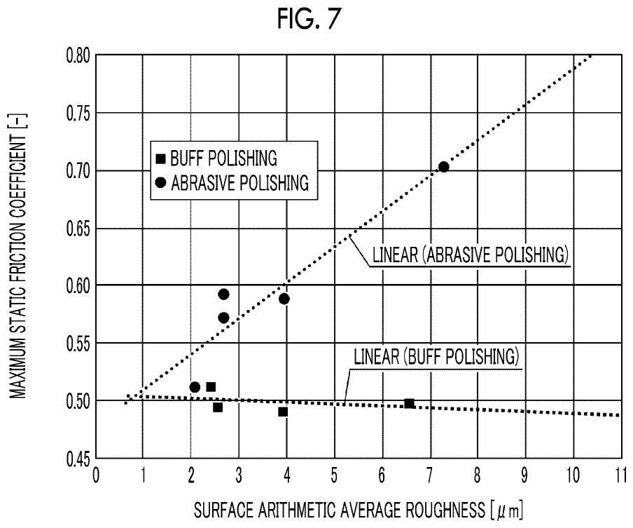

FIG. 7 is a graph showing a relationship between the arithmetic average roughness [μm] of the outer peripheral surface of the drying cylinder and the maximum static friction coefficient. FIG. 7 shows a drying cylinder of which an outer peripheral surface is subjected to the abrasive polishing and a drying cylinder of which an outer peripheral surface is subjected to the buff polishing. Dotted lines shown in FIG. 7 are approximate straight lines for plotted points of the abrasive polishing and plotted points of the buff polishing. As shown in FIG. 7, in the abrasive polishing, the maximum static friction coefficient increases as the arithmetic average roughness increases, but in the buff polishing, the maximum static friction coefficient hardly changes even though the arithmetic average roughness increases.

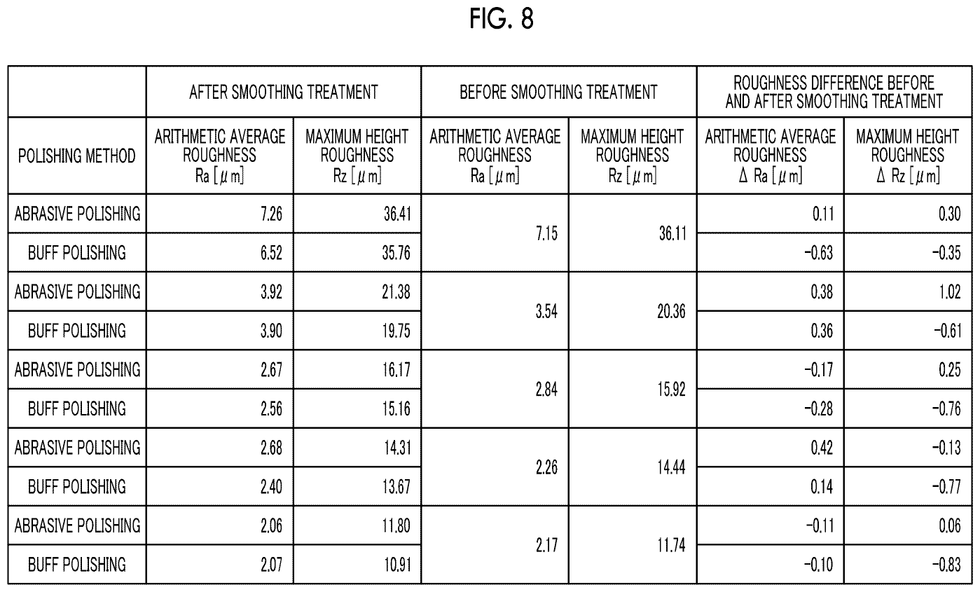

FIG. 8 is a table showing the arithmetic average roughness of the outer peripheral surface of the drying cylinder before and after the smoothing treatment. As shown in FIG. 8, in a case of the abrasive polishing, a maximum height roughness Rz [μm] was increased before and after polishing. On the other hand, in a case of the buff polishing, the maximum height roughness Rz was reduced by 0.35 [μm] or more before and after polishing. That is, as the method of processing the drying cylinder, it is preferable to reduce the maximum height roughness of the outer peripheral surface of the drying cylinder by 0.35 or more in the smoothing treatment of the buff polishing.

### [Solvent Amount of Ink on Substrate]

After the image is formed, the substrate S is dried by the radiation heating unit 34 and the drying cylinder 36. In a case where the drying is too weak, an image surface is very sticky, and thus the measures for the drying cylinder 36 described above may not be sufficient.

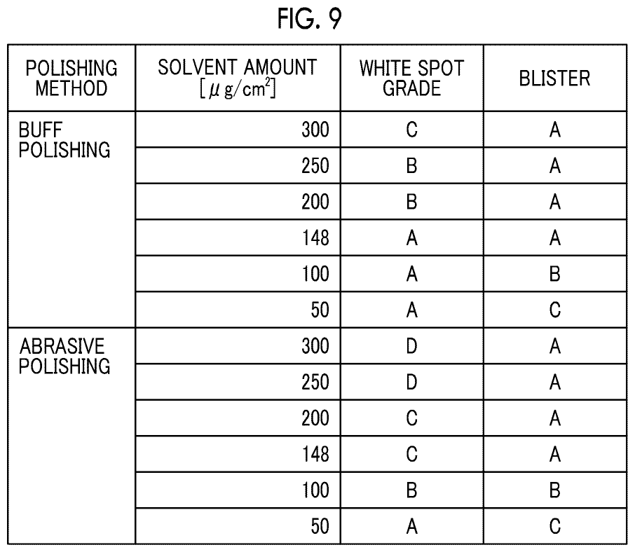

The occurrence of white spots and blisters was evaluated for the drying cylinder of which the outer peripheral surface was subjected to the buff polishing and the drying cylinder of which the outer peripheral surface was subjected to the abrasive polishing. Here, the solvent amount of the ink on the recording surface of the substrate was changed to 50 to 300 [μg/cm²]. The solvent of the ink is uniformly distributed in each substrate. In FIG. 9, the evaluation of the occurrence of the white spots and the blisters was determined as follows. The grades A, B, and C are pass, and the grade D is fail.
A: very good
B: good
C: acceptable
D: unacceptable

FIG. 9 is a table showing evaluation results of white spots and blisters. As shown in FIG. 9, in the drying cylinder of which the outer peripheral surface is subjected to the buff polishing, the occurrence of white spots and blisters was determined to be the grade C or higher in a case where the solvent amount was in a range of 50 to 300 [μg/cm²]. On the other hand, in the drying cylinder of which the outer peripheral surface was subjected to the abrasive polishing, the occurrence of white spots was determined to be the grade D in a case where the solvent amount was 300 [μg/cm²] and 250 [μg/cm²].

From this result, it was found that the solvent amount of the ink on the recording surface of the substrate that comes into contact with the outer peripheral surface of the drying cylinder is preferably 200 [μg/cm²] or less, and more preferably 148 [μg/cm²] or less. The solvent amount of the ink on the front surface of the substrate S that comes into contact with the outer peripheral surface 36B of the drying cylinder 36 of the back surface printing and main drying unit 20 can be set to a desired solvent amount by drying the substrate S by the radiation heating unit 34 and the drying cylinder 36 of the front surface printing and main drying unit 16.

It is preferable that the solvent amount of the ink is small, but since excessive drying can affect the quality of the printed matter itself, such as causing blisters, it is practically preferable that the solvent amount is 50 [μg/cm²] or more.

In order to satisfy this solvent amount, temperatures of the radiation heating unit 34 and the drying cylinder 36 are adjusted such that the temperature of the substrate S is in a range of 90 [° C.] or more and 180 [° C.] or less. That is, the drying cylinder 36 sets the temperature of the substrate S to 90 [° C.] or higher and 180 [° C.] or lower while the substrate S is in contact with the drying cylinder 36.

### [Other Conditions]

Since the maximum static friction coefficient is often 0.1 or more regardless of whether the material is a metal or a non-metal, the maximum static friction coefficient of the outer peripheral surface 36B of the drying cylinder 36 is set to 0.1 or more. In addition, the arithmetic average roughness of the outer peripheral surface 36B of the drying cylinder 36 is set to 10.4 [μm] or less obtained from an intersection point between an approximate straight line for the plotted points of the abrasive polishing shown in FIG. 7 and 0.8, which is a realistic value of the maximum static friction coefficient. The measures for the outer peripheral surface 36B of the drying cylinder 36 described above become more effective by satisfying the following.

In the ink jet recording device 10, the transport tension of the substrate S is set in a range of 50 [N/m] or more and 800 [N/m] or less according to the transport speed of the substrate S and the application. In addition, the temperature of the outer peripheral surface of the drying cylinder 36 is set in a range of 30 [° C.] or more and 300 [° C.] or less according to the transport speed and the type of the substrate S. Since the drying cylinder 36 is driving, and no speed difference occurs between the drying cylinder 36 and the substrate S, image defects are less likely to occur than in a case where the drying cylinder 36 is driven.

The substrate S is paper. The paper is not limited to inkjet dedicated paper, and includes paper mainly composed of cellulose, such as coated paper. For example, the substrate S may be art paper, coated paper, lightweight coated paper, cast paper, or fine coated paper. The substrate S may have a moisture content of 1.2% or more and 14.3% or less before the ink is applied to the recording surface. In a case where an image is formed on the front surface of the substrate S, the moisture content of the substrate S can be adjusted by the pre-drying unit 14. In a case where an image is formed on the back surface of the substrate S, the moisture content of the substrate S can be adjusted by the radiation heating unit 34 and the drying cylinder 36 of the front surface printing and main drying unit 16.

A melting point of the wax contained in the ink is important for reducing stickiness. The melting point of the wax may be 90° C. or lower. The melting point of the wax is preferably as low as possible as long as the wax does not bleed at room temperature (the wax does not separate and precipitate on the surface of the image), but a low melting point of a paraffin wax of 47° C. or higher is appropriate.

With the ink jet recording device 10 that satisfies the above-described conditions, the drying cylinder 36 can achieve its original purpose of contact heating the substrate, without damaging the image surface, and can suppress slippage during transport.

### Modification Example of Printing and Main Drying Unit

### First Modification Example

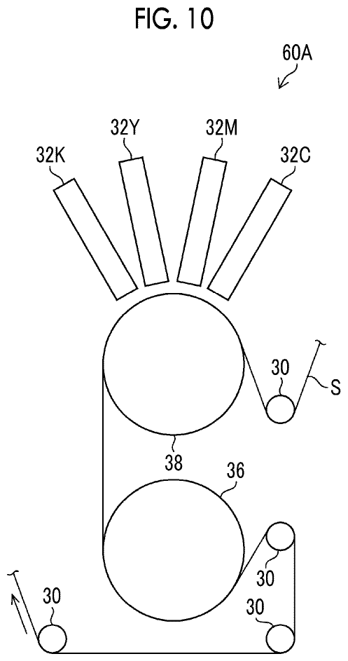

FIG. 10 is a configuration diagram showing an outline of a printing and main drying unit 60A according to a first modification example. Parts common to FIG. 2 will be designated by the same reference numerals and will not be described in detail.

The printing and main drying unit 60A comprises ink jet heads 32C, 32M, 32Y, and 32K and a printing cylinder 38.

The plurality of pass rollers 30 are disposed on a transport path of the substrate S in the printing and main drying unit 60A. The substrate S carried into the printing and main drying unit 60A is transported to the printing cylinder 38 by the pass rollers 30. The substrate S is wound around an outer peripheral surface of the printing cylinder 38.

The printing cylinder 38 is rotationally driven by a motor (not shown) about a rotation shaft (not shown). In addition, the printing cylinder 38 holds an opposite surface of the substrate S opposite to the recording surface on the outer peripheral surface and rotates about the rotation shaft to transport the substrate S. The outer peripheral surface may be provided with an adsorption hole for adsorbing the substrate S to the outer peripheral surface.

The ink jet heads 32C, 32M, 32Y, and 32K are liquid jetting heads that jet aqueous inks of cyan (C), magenta (M), yellow (Y), and black (K) by an ink jet method, respectively. Each of the ink jet heads 32C, 32M, 32Y, and 32K is disposed at regular intervals along the transport path of the substrate S using the printing cylinder 38.

Here, a configuration in which four colors of inks of cyan, magenta, yellow, and black are used is exemplified, but the combination of the ink colors and the number of the colors are not limited to the present embodiment, and light ink, dark ink, and special color ink may be added as necessary.

The substrate S which is transported by the printing cylinder 38 and has the recording surface on which the image is formed by the ink jet heads 32C, 32M, 32Y, and 32K is transported to the drying cylinder 36.

### Second Modification Example

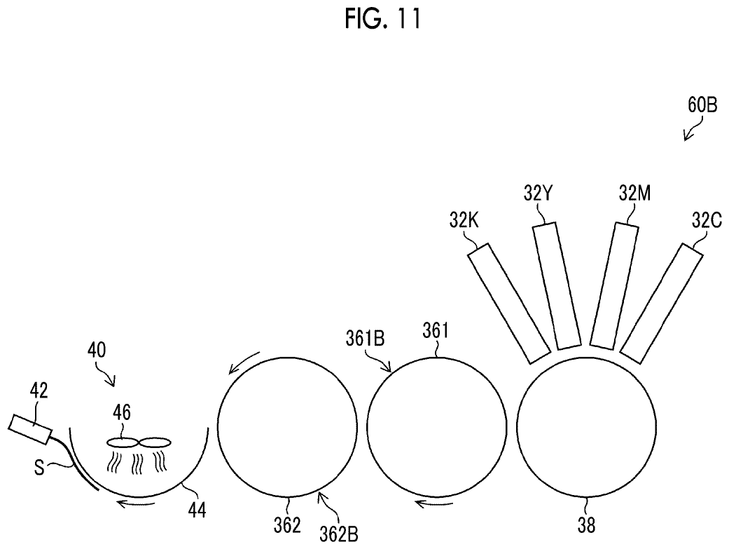

FIG. 11 is a configuration diagram showing an outline of a printing and main drying unit 60B according to a second modification example. Parts common to FIG. 10 will be designated by the same reference numerals and will not be described in detail.

The printing and main drying unit 60B is a unit for forming an image on the recording surface of the substrate S in a sheet form, and comprises a first drying cylinder 361, a second drying cylinder 362, and a cooling unit 40.

The substrate S which is transported by the printing cylinder 38 and has the recording surface on which the image is formed by the ink jet heads 32C, 32M, 32Y, and 32K is delivered from the printing cylinder 38 to the first drying cylinder 361.

The first drying cylinder 361 rotates about a rotation shaft with a first outer peripheral surface 361B in contact with the recording surface of the substrate S, thereby transporting the substrate S while heating the substrate S from the recording surface. The substrate S on which drying of the aqueous ink is promoted is delivered from the first drying cylinder 361 to the second drying cylinder 362.

The second drying cylinder 362 rotates about a rotation shaft by bringing a second outer peripheral surface 362B into contact with the opposite surface of the substrate S opposite to the recording surface, thereby transporting the substrate S while heating the substrate S from the opposite surface. The substrate S on which drying of the aqueous ink is promoted is delivered from the second drying cylinder 362 to the cooling unit 40.

The cooling unit 40 comprises a holding portion 42, a sliding cooling member 44, and a cold air fan 46. The holding portion 42 holds a tip part of the substrate S delivered from the second drying cylinder 362 and transports the substrate S in a transport path along the sliding cooling member 44. The substrate S transported by the holding portion 42 has a recording surface that slides on the sliding cooling member 44. The sliding cooling member 44 is cooled by the cold air fan 46 from a side opposite to a surface on which the substrate S slides. Therefore, the substrate S is cooled by the sliding cooling member 44 and is discharged to the outside of the printing and main drying unit 60B.

### <Others>

In the present embodiment, an example of paper has been described as the substrate S, but various recording media can be used as the substrate S regardless of the material and shape, such as a resin sheet and a film.

The technical scope of the present invention is not limited to the scope according to the embodiment described above. The configurations and the like in each embodiment can be appropriately combined between the embodiments without departing from the gist of the present invention.

### EXPLANATION OF REFERENCES

10: ink jet recording device
12: paper feed unit
14: pre-drying unit
16: front surface printing and main drying unit
18: reversing unit
20: back surface printing and main drying unit
22: paper discharge unit
30: pass roller
32: ink jet head
32C: ink jet head
32K: ink jet head
32M: ink jet head
32Y: ink jet head
34: radiation heating unit
36: drying cylinder
36A: rotation shaft
36B: outer peripheral surface
36C: heater
36D: motor
38: printing cylinder
40: cooling unit
42: holding portion
44: sliding cooling member
46: cold air fan
50: overall control unit
50A: processor
50B: memory
52: transport control unit
54: pre-drying control unit
56: printing control unit
58: drying control unit
60: printing and main drying unit
60A: printing and main drying unit
60B: printing and main drying unit
361: first drying cylinder
361B: first outer peripheral surface
362: second drying cylinder
362B: second outer peripheral surface
S: substrate

What is claimed is:

1. An ink jet recording device comprising:
an ink jet head that applies an ink to a recording surface of a recording medium to form an image; and
a drying cylinder that heats the recording medium by bringing the recording surface of the recording medium to which the ink is applied into contact with an outer peripheral surface of the drying cylinder,
wherein the outer peripheral surface of the drying cylinder has a maximum static friction coefficient of 0.54 or less and an arithmetic average roughness of 1.6 μm or more, and
a solvent amount of the ink on the recording surface that comes into contact with the outer peripheral surface of the drying cylinder is 200 μg/cm² or less.

2. The ink jet recording device according to claim 1, further comprising:
a transport device that transports the recording medium,
wherein the transport device applies a tension of 50 N/m or more and 800 N/m or less to the recording medium.

3. The ink jet recording device according to claim 1,
wherein the drying cylinder includes a heater, and
the heater sets a temperature of the outer peripheral surface of the drying cylinder to 30° C. or higher and 300° C. or lower.

4. The ink jet recording device according to claim 1,
wherein the drying cylinder includes a motor that rotates the drying cylinder about a shaft of the drying cylinder, and
the drying cylinder transports the recording medium while holding the recording medium on the outer peripheral surface.

5. The ink jet recording device according to claim 1,
wherein a moisture content of the recording medium before the ink is applied to the recording surface is 1.2% or more and 14.3% or less.

6. The ink jet recording device according to claim 1,
wherein the drying cylinder sets a temperature of the recording medium to 90° C. or higher and 180° C. or lower.

7. The ink jet recording device according to claim 1,
wherein the ink contains a wax, and
a melting point of the wax is 90° C. or lower.

8. The ink jet recording device according to claim 1,
wherein the outer peripheral surface of the drying cylinder has the maximum static friction coefficient of 0.1 or more and the arithmetic average roughness of 10.4 μm or less, and
the solvent amount of the ink on the recording surface that comes into contact with the outer peripheral surface of the drying cylinder is 100 μg/cm² or more.

9. An ink jet recording device comprising:
a first ink jet head that applies an ink to a first recording surface of a recording medium to form an image;
a first drying cylinder that heats the recording medium by bringing a second recording surface, which is an opposite surface of the first recording surface of the recording medium to which the ink is applied, into contact with a first outer peripheral surface;
a reversing mechanism that reverses front and back sides of the recording medium;
a second ink jet head that applies the ink to the second recording surface of the recording medium to form an image;
a second drying cylinder that heats the recording medium by bringing the first recording surface of the recording medium into contact with a second outer peripheral surface,
wherein a solvent amount of the ink on the first recording surface in the first drying cylinder is 200 μg/cm² or less, and
the second outer peripheral surface of the second drying cylinder has a maximum static friction coefficient of 0.54 or less and an arithmetic average roughness of 1.6 μm or more.

10. A method of manufacturing a drying cylinder, comprising:
performing a roughening treatment on an outer peripheral surface of a cylinder having a cylindrical shape; and
performing a smoothing treatment on the outer peripheral surface on which the roughening treatment is performed, to make the outer peripheral surface have a maximum static friction coefficient of 0.54 or less and an arithmetic average roughness of 1.6 μm or more.

11. The method of manufacturing a drying cylinder according to claim 10,
wherein, in the smoothing treatment, a maximum height roughness of the outer peripheral surface of the cylinder is reduced by 0.35 μm or more.

12. The method of manufacturing a drying cylinder according to claim 10,
wherein the smoothing treatment is performed by buff polishing.
